(19) United States
(12) Patent Application Publication
(10) Pub. No.: US 2007/0162299 A1
(43) Pub. Date: Jul. 12, 2007

(54) MATERIALS LOCATION SYSTEM AND SELECTING METHOD OF MATERIALS RECEIVING LOCATIONS

(76) Inventors: Atsuko Ito, Hitachinaka (JP); Kenji Araki, Mito (JP); Satoru Ono, Hitachinaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/621,672

(22) Filed: Jan. 10, 2007

(30) Foreign Application Priority Data
Jan. 12, 2006 (JP) 2006-004321

(51) Int. Cl. G06Q 99/00

(52) U.S. Cl. 705/1

(57) ABSTRACT

Working efficiency improvement of shipping and receiving operations in a materials storage location is contemplated. An optimal location is provided so as to minimize work volume in shipping operation when receiving materials control objects in a materials storage location to improve working efficiency in the materials stockroom. As means to achieve it, a location information of the materials control objects stocked in the materials storage location and vacant area where the materials control objects to be received can be stocked are calculated by use of location information of the materials control objects in the materials storage location and materials dimensions and shape information represented by the three-dimensional CAD used in design to select and decide the area to minimize work volume when shipping. Consequently, shipping operation efficiency can be improved. Further, provision of means to obtain automatically location information of the stocked materials control objects enables to obtain location information of the stocked materials control objects at a spot away from the materials storage location, and thus makes it possible to reduce traveling time of operators to the materials storage location.

### BACKGROUND OF THE INVENTION

1. Field of the Invention

This invention relates to a materials location system and a selecting method of materials receiving locations for providing storage locations of materials control objects and materials receiving method to an operator at materials receiving operation and for providing the location information of materials to be shipped and an optimal shipping procedures to an operator at materials shipping operation. The storage locations of the materials control objects and the receiving method make the number of materials carriers and the work volume of an operator to be minimum at the materials shipping operation. The restriction conditions of materials carries are considered into the optimal shipping procedure.

2. Description of the Related Art

Conventional techniques in materials control engineering will be described here taking an example of materials control objects in a plant construction site and a materials storage location which is a place to stock the materials control objects. Each material control object is entitled with a unique material name which is inscribed or painted on the material body, or written on a label to identify the materials control object. The materials storage location is controlled in general for each certain sized area using stock area name, and the locations of the materials control objects on shipping and receiving are handled by using the stock area names for information collection and confirmation. When receiving the materials control objects, an operator confirms visually a vacant area in the materials storage location where the materials control objects to be received can be stocked and guides a materials carrier such as a truck. Materials control objects loaded on the materials carrier is discharged and the name written on the materials control object is associated with the stock area name for discharged materials and the associated storage location information is recorded. In shipping, based on the material name requested to ship out and the stock area name corresponding to the material name, which was recorded when received, the materials control object in concern is searched and loaded on the materials carrier for shipping. The name of shipped material is recorded. Through accumulation of these information, stock materials in a materials storage location and storage locations are controlled.

In Patent document 1 (JP-A-2001-349058), such a device is provided that a memory chip, GPS receiver and communication means are provided in a materials control object, and location information of the materials control object is output following the shipping sequence, aiming at reduction of search work for materials control object in the occasion of shipping of the materials control object from the materials storage location.

In Patent document 2(JP-A-2005-170607), such a device is provided that registers stocking method of materials control object based on each type of the objects in advance, discriminates the stocking method based on the type when receiving the materials control object, determines the storage location based on the discrimination, and indicates the location to be stocked to an operator, which provides a method to stock materials through classifying depending on types.

### SUMMARY OF THE INVENTION

In receiving of the materials control object, materials control objects having approximately same shipping timing are generally delivered in a lot in most cases. In some cases, however, products having different shipping timings are delivered in a lot due to alterations of production processes of the materials control objects or design changes. When such shipping and receiving of the materials control objects are repeated, materials control objects having different shipping timings are remained in a scattered manner in a materials storage location, failing to keep a lump of vacant areas, which may deteriorate workability in receiving operation. Owing to this, during a stage having a certain scale of remained materials control objects in the materials storage location, materials transfer is implemented. Due to the fact that the transferred materials control objects do not exist at the registered storage location when received any more, searching operation is required when shipping. Moreover such a case occurs frequently that transferred materials are placed in different locations from a group of products having the same shipping timing, which requires movement of the materials carrier so as to load the materials control objects and the like and causes deterioration in work efficiency.

In addition, in raw materials stockroom as well, it is necessary to stock the raw materials in a limited range of space. Therefore the materials are stacked sometimes, which may require additional time to take out the necessary materials located underneath newly stocked materials.

In order to solve the problems described so far, a materials location system according to the present invention includes a materials location control device, a materials control device and a materials shipping and receiving instruction device in order to provide an optimal location information of the materials control objects in an occasion of receiving the materials control objects so as to minimize work volume related to shipping operation.

The materials location control device specifies the location coordinates of stocked materials control objects, combines with design information of the materials control objects and hence calculates the location information of the stocked materials control objects, and areas and coordinates of vacant areas where no materials control object is allocated.

The materials control device specifies an optimal receiving area so that the work volume is minimized when shipping the materials control objects to be received and when discharging the shipped materials control objects, making use of the information calculated by the materials location control device, design information and process information of the receiving materials control objects.

Specified receiving area information is transmitted to the materials shipping and receiving instruction device which is hand-carried by operators. The materials shipping and receiving instruction device indicates the receiving area on a map or display the coordinates. In case of controlling via grouping numbers and the like, the numbers may be indicated. Operators can allocate the materials control objects at the optimal area based on the information obtained by the materials shipping and receiving instruction device. Owing to this, the work volume related to shipping can be depressed remarkably in the occasion of shipping.

Moreover the materials control device transmits the location coordinates information of the materials control objects of shipping objects to the materials shipping and receiving instruction device also when shipping, and presents the optimal materials carrier or shipping procedure, which enabling to enhance further the shipping operation efficiency.

Use of the materials location system according to the present invention provides optimal receiving area information without visual confirmation of the materials storage location through inputting the receiving materials information when receiving the materials control objects. When shipping, the most efficient shipping procedure is provided taking into account the location of the materials control objects to be shipped and loading capacity, loading method, number of times of loading and the like of the materials carrier. Thereby, relocation of the materials control objects in the storage location, shipping less than the loading capacity of the materials carrier when shipping, work reduction of an identical materials carrier in the materials storage location and multiple times of loading can improve working efficiency in the materials storage location. While improving working efficiency in shipping in the materials storage location as described above, an optimal method is to be selected so that no materials searching operation is occurred even in discharging the shipped materials. Further situation of the materials storage location can be grasped without frequent visits there, which contributes to reduction in traveling time and safety improvement of operators.

### BRIEF DESCRIPTION OF THE DRAWINGS

FIG. 1 shows the overall structure of a materials location system.

FIG. 2 shows an example of a location detection means of a stocked materials control object.

FIG. 3 shows an application example of the present invention at a materials storage location.

FIG. 4 shows an outline of operation flow of materials shipping and receiving method according to the present invention.

FIG. 5 shows a program flow chart of a materials location control device 1.

FIG. 6 shows a materials receiving program flow chart of a materials control device 2.

FIG. 7 shows an operation chart of a materials shipping and receiving instruction device 5 when receiving the materials control objects.

FIG. 8 shows a materials shipping program flow chart of the materials control device 2.

FIG. 9 shows an operation chart of the materials shipping and receiving instruction device 3 when shipping the materials control objects.

FIG. 10 shows an application example of the present invention to a raw materials storage warehouse.

### DESCRIPTION OF THE PREFERRED EMBODIMENTS

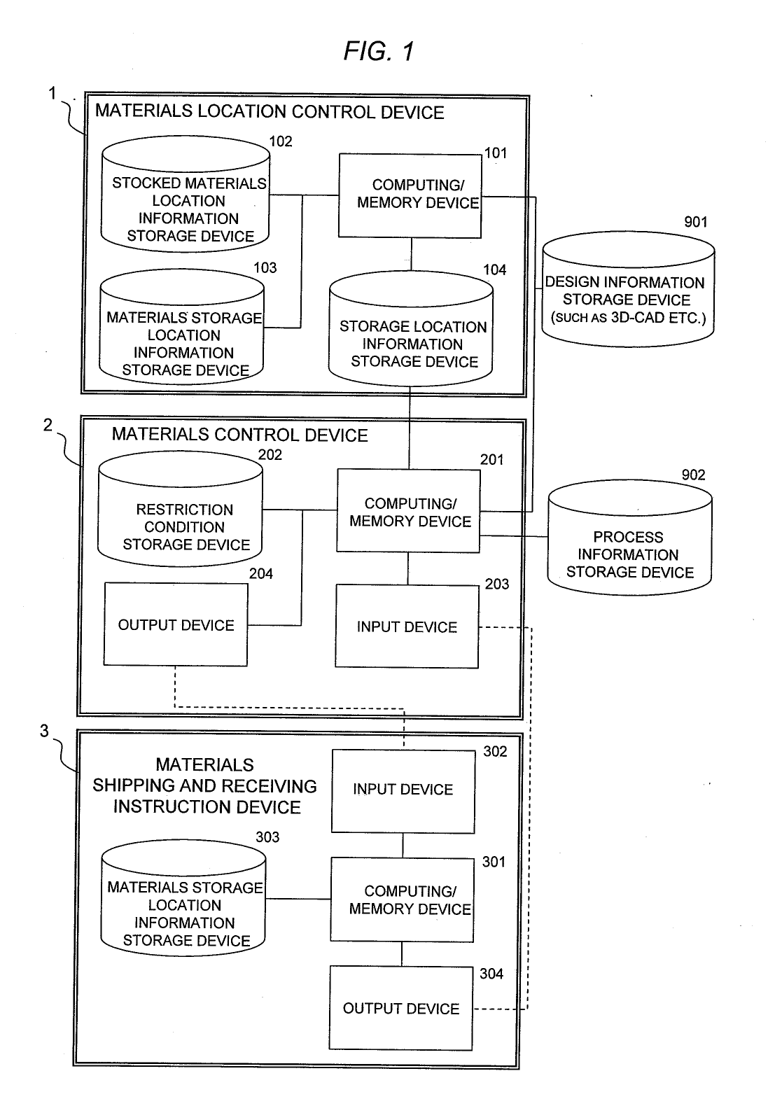

One embodiment of the present invention is described according to drawings. FIG. 1 shows an overall structure of the materials location system. The materials location system comprises a materials location control device 1, a materials control device 2 and a materials shipping and receiving instruction device 3, to provide optimal location information of the materials control objects when receiving the materials control objects so as to minimize work volume when shipping.

The materials location control device 1 comprises a computing/memory device 101, which calculates location of the materials control objects stocked in the materials storage location and the vacant areas where the materials control objects are not placed, a stocked materials location information storage device 102, which stores the location information of the stocked materials control objects, a materials stock area information storage device 103, which stores the materials stock area information, a stock location information storage device 104, which stores the information calculated by the computing/memory device 101, and a design information storage device 901 of the materials control object, which is located outside and communicates when necessary. The computing/memory device can also serves as each storage device. The design information storage device 901 may be integrated into the materials location control device 1. The design information storage device 901 stores information to obtain the floor area required for stock of each materials control object, which are equivalent to three-dimensional CAD or design drawing information showing specifically size, shape, and volume, and manufacturing and process information of the materials.

The materials control device 2 comprises a computing/memory device 201, which calculates receiving position so that work volume for shipping is minimized when receiving the materials control objects, a restriction condition storage device 202, which stores information such as notices during stock for every material type or materials carrier specifications for shipping, an input device 203 to input instructions of shipping and receiving of the materials control objects and the like, an output device 204 to direct the operators receiving area and receiving method of the materials control objects which are calculation results, and information of location and shipping method of the materials control objects to be shipped, a design information storage device 901, which is located outside and executes communication if necessary, and a process information storage device 902, which stores process information of the materials control objects. The computing/memory device 201 may serve as the restriction condition storage device 202 as well. The design information storage device 901 and the process information storage device 902 may be integrated into the materials control device 2. Also the materials control device 2 may serve as the materials location control device 1 as well, in which case the computing/memory device 201 serves as the computing/memory device 101 as well.

The materials shipping and receiving instruction device 3 comprises an input device 302 to receive instruction information from the materials control device 2, a materials storage location information storage device 303 to store information such as a map of the materials storage location and the coordinates, a computing/memory device 301 to combine the instruction information with the materials storage location information, and an output device 304, which indicates operators by means of display on a screen, output or the like, receiving area and receiving method of the materials control objects and information of the locations of shipping objects and shipping method which are shown on a materials storage location map. In addition, when shipping and receiving operation of the materials control objects is completed, an operation completion record may be transmitted from the output device 304 to report to the materials control device 2. The computing/memory device 301 may serve as the materials storage location information storage device 303 as well. The materials shipping and receiving instruction device 3 is preferably specified to be portable by operators. Computing function of the computing/memory device 301 and the materials storage location information storage device 303 may be integrated into the materials control device 2, in which case the materials shipping and receiving instruction device 3 includes the input device 302, the output device 304 to output received information and the computing/memory device 301 to operate each device.

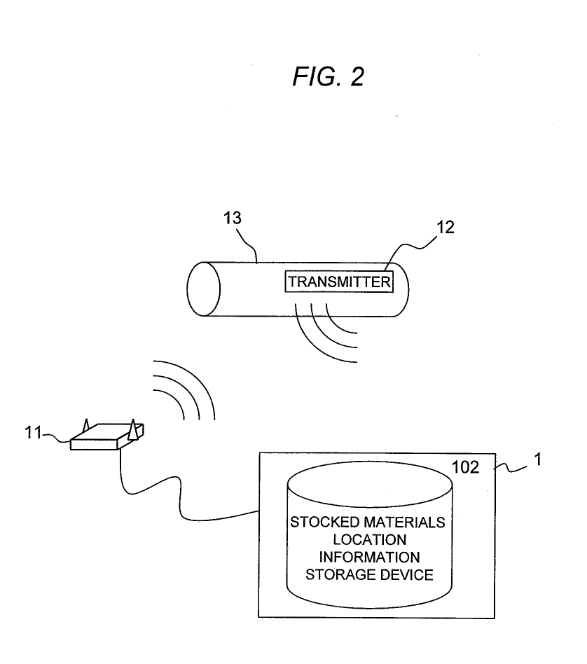

FIG. 2 shows an example of a method to collect location information of stocked materials control objects stored in the stock materials location information storage device 102 of the aforementioned materials location control device 1. This method is composed of a base station 11 located in a materials storage location and detecting locations via radio wave transmitting/receiving in non-contact manner, a transmitter 12 transmitting information memorized in advance, and the materials control object 13 attached with the transmitter 12. The transmitter 12 can adopt such a device that can memorize various information to identify the materials such as a specific ID or a material name, for example RFID and the like. Here, the specific ID and the material name are supposed to be memorized in advance. The base station 11 can obtain the specific ID, the material name and the location information through communication with the transmitter 12. In addition a communication device is integrated so as to transmit the obtained location information. FIG. 2 shows an example. Collecting method of location information of the stocked materials control objects may be the visually confirmed information by an operator, information measured by measuring instruments or information measured by using GPS (Global Positioning System).

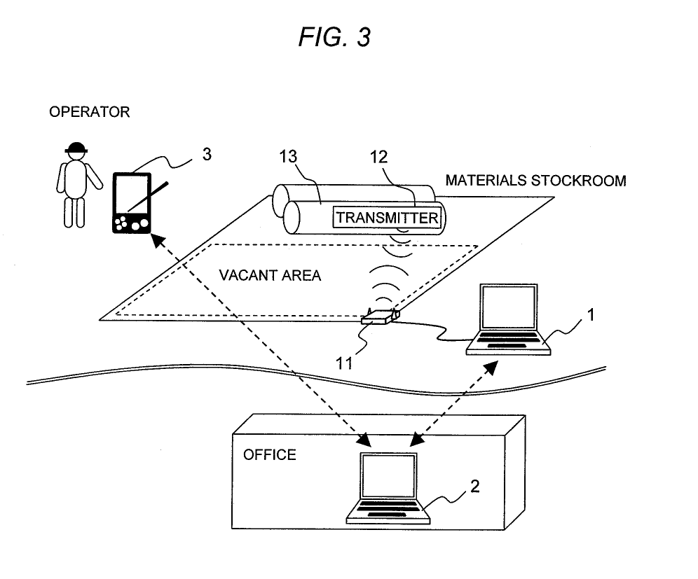

An example of the overall configuration of the system described so far is shown in FIG. 3. The name and the location of the materials control object 13 attached with the transmitter 12 is arranged to be detected automatically using the base station 11 located in the materials storage location, and the materials location control device 1 communicating with the base station 11 is arranged in the vicinity of the materials storage location. For example, an office and the like where the stock operators work is adapted. In case such availability does not exist, the materials control device 2 may cover the function of the materials location control device 1. The materials control device 2 is located in an office so that the overall activity of the materials location system can be monitored in the office. The materials shipping and receiving instruction device 3 is hand-carried by operators in the materials storage location and the instruction of shipping and receiving can be received to confirm even while working at site. Each device can communicate with each other via communication devices integrated therein to transmit and receive information.

### The First Embodiment

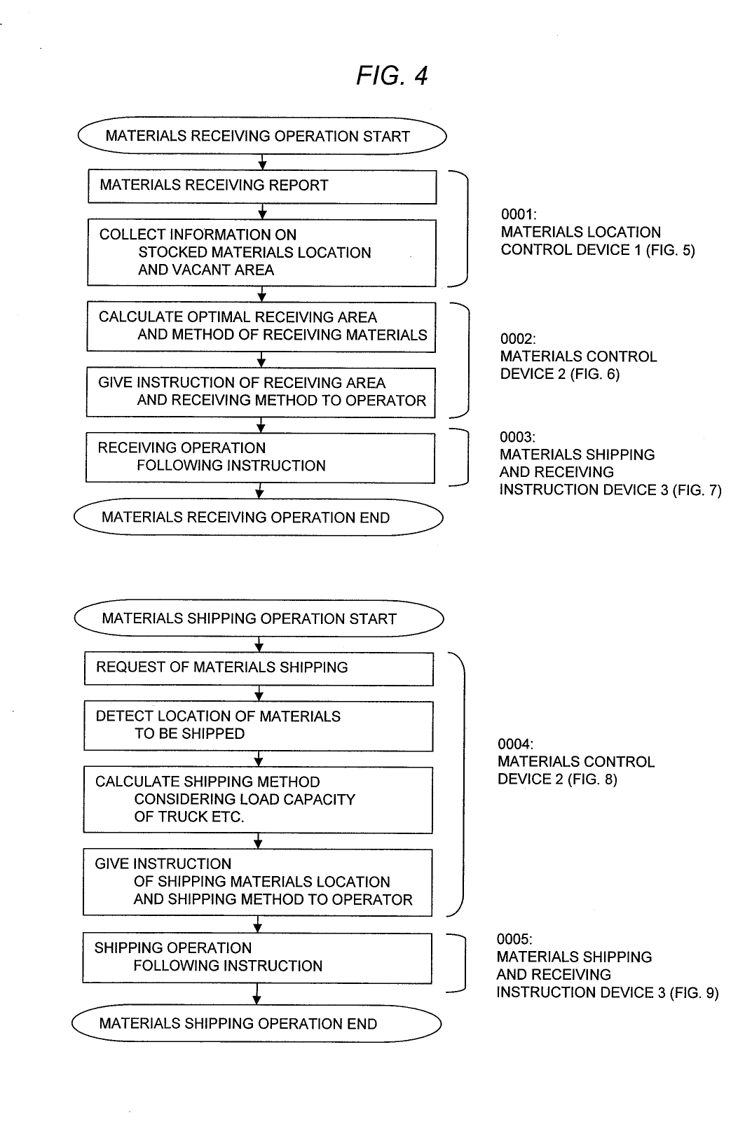

Taking as an example the overall configuration of the system shown in FIG. 3, the operation flow of a series of shipping and receiving operation of the materials control object is shown in FIG. 4. Details of each operation are described referring to following drawings. Firstly receiving operation of the materials control objects includes: a report is received to receive the materials control objects; to collect information of location of the stocked materials control objects and vacant area at the materials location control device 1 (Step 0001); based on the information, the materials control device 2 calculates the optimal receiving area of the materials control objects subject to receiving and the allocating method at the receiving area and instruct the results to the operator (Step 0002); the operator receives the materials control objects following the instruction received by the materials shipping and receiving instruction device 3 (Step 0003); and receiving operation is completed.

Next in the shipping operation, shipping request of the materials control objects is received, and the location of the materials control objects which is to be shipped is detected in the materials location control device 1. Next, considering the location of the materials control objects which is to be shipped and the restriction condition such as the load capacity of the materials carrier and the like in the materials control device 2, also considering which materials carrier is to be used to transport the materials to be shipped, movement of the materials carrier, and the number of times of shipping and the like, shipping method is calculated so that work volume related to shipping operation is minimized and the location of the materials control objects to be shipped and shipping method is directed to the operator (Step 0004). Operators carry out shipping operation following the instruction received by the materials shipping and receiving instruction device 3 which is hand-carried by the operator (Step 0005), and then materials shipping operation is completed. Operation content in each step will be described in detail bellow.

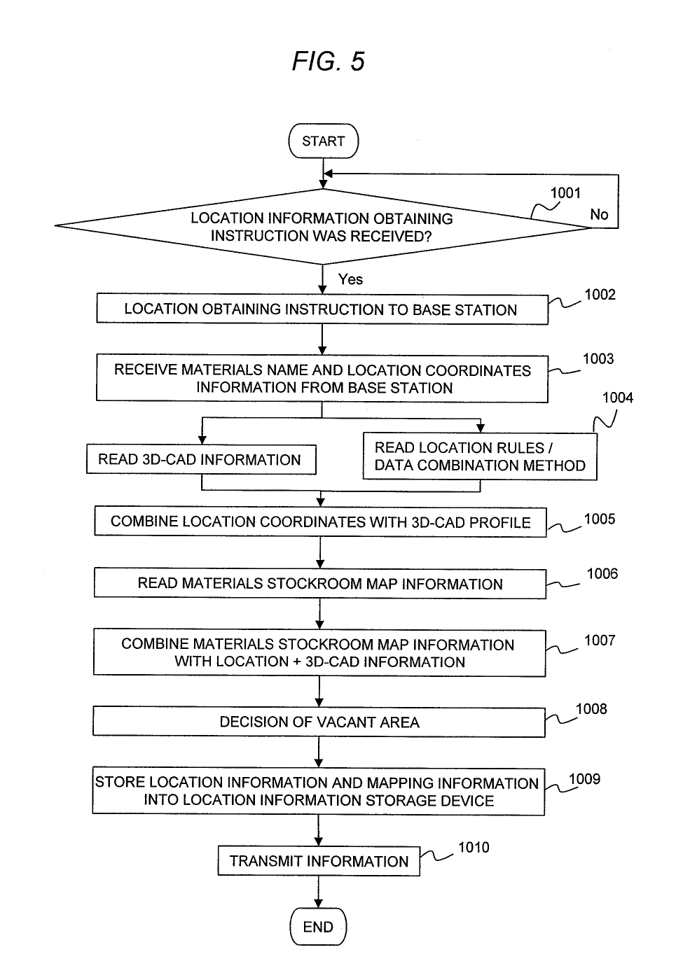

Operation of the materials location control device 1 and location detection method thereof is described taking an example of operations according to the operation flow chart in FIG. 5. The materials location control device 1 is to be operated periodically and is also operated in similar way even when receiving a location information obtaining instruction. The computing/memory device 101 receives the location information obtaining instruction (Step 1001). Location obtaining instruction of the stocked materials control objects is transmitted to the base station 11 which is attached to the materials storage location (Step 1002). The base station 11 obtains the location coordinates via non-contacting communication with the transmitter 12 which is attached to the stocked materials control objects 13, and the specific ID of the transmitter 12, the material name, location coordinates and date/time of location detection are transmitted to the materials location control device 1 (Step 1003). The information received from the base station 11 is stored in the stock materials location information storage device 102 of the materials location control device 1. Computing/memory device 101 reads the design information such as 3-dimensional profile data including dimensions, size, as well as weight of the materials control object concerned from the design information storage device 901 taking as a key the specific ID and/or the material name of the stocked materials control object, and calls location rules information and data combination means of the materials control object which have been predetermined in the computing/memory device 101 (Step 1004) to combine the location data with the profile data of the materials control object concerned (Step 1005). The allocation rules include placing method of the materials control object, fixing place of the transmitter and location information from the transmitter in stock state if the number of transmitters attached to the materials control object is singular, and in case where the number of the transmitters is plural and the direction of the materials control object can be determined by the transmitter, the transmitter fixing location information is included. The combined data is called the materials location data. Next, the computing/memory device 101 reads the map information, coordinates and area size information of the materials control object from the materials storage location information storage device 103 (Step 1006). The materials storage location information and the materials location data which were read are combined to give the location information of the stocked materials control object (Step 1007). From the location information, any area where no materials are placed and there is larger area than a specified size is determined to be vacant area (Step 1008). Location information on the stocked materials control object and the vacant area information are stored in the location information storage device 104 (Step 1009), further the information is transmitted to the materials control device 2 (Step 1010), which is the source of the location information obtaining instruction. Owing to this, the stocked materials location information can be readily obtained without interrupting operators. It is conceivable that the transmitter 12 is attached on the materials control object when shipping from manufacturing or processing floor or in the occasion of materials receiving at site. However the timing and means of the transmitter attaching to the object does not matter if the transmitter has been attached to the object on the spot of stocking in the materials storage location.

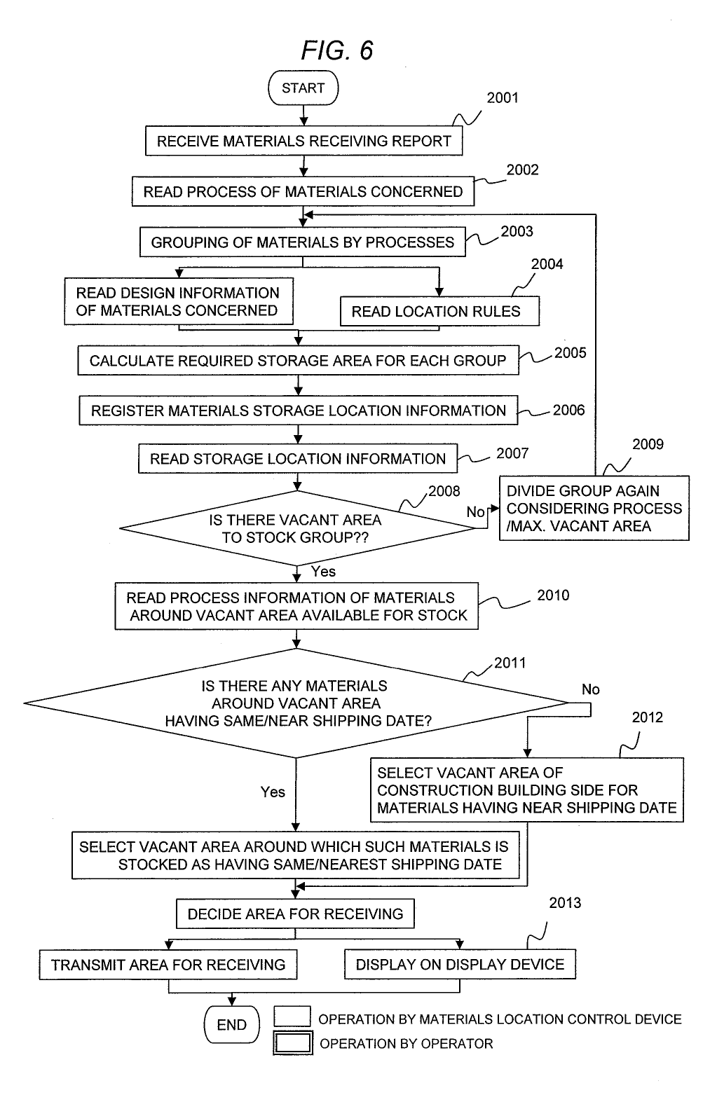

The operation of the materials control device 2 is described as an example of the operation according to a program flow chart in FIG. 6. When the report of receiving of the materials control objects by an operator or by the materials control device 2 (Step 2001), such process information is read from the process information storage device 902 as the shipping date of the materials control object concerned from the materials storage location, the material time limit required in an installation area, and the like (Step 2002). The receiving report of the materials control object includes material name to be received, materials transportation note, delivery documentation, inspection record at the factory, shipping date, delivery request date at the site, and the like. If the information includes the shipping date from the materials storage location or the group which is planned to be shipped at the same timing, the above mentioned information is not always necessary. And in a case where the materials control objects of the same timing shipping are planned to be delivered with a different shipment due to delay or production process influence, the information of the materials control object shipped afterward and its receiving schedule is to be included. This is because a stock area is reserved for the materials control object to be received afterwards at the area adjacent to the area of the materials control object shipped in earlier. Hereinafter, this is called the reservation of area. The receiving materials control objects are grouped under shipping date from the materials storage location or delivery request date at the site by use of the read process information (Step 2003). The allowable range of a same shipping date or delivery request date at the site is to be registered in advance. The groups may be a single or plural. Also, shipping date or delivery request date at the site, which is the base of grouping, is fixed by each installation unit such as drawings for construction works. Therefore, the grouping unit may be decided by a unit of the same timing construction work based on work plans. If there are receiving materials control objects in different shipment, grouping is performed including such materials control objects in order to reserve the area. Next, the design information of the materials control object concerned is read from the design information storage device 901, the computing/memory device 201 calls the allocation rules (Step 2004), and a area of the materials storage location required to stock each group is calculated (Step 2005). The optimal materials location method to minimize the necessary area for stock, which is calculated in the calculation process, is stored in computing/memory device 201 (Step 2006). Next, the location information of the stocked materials control object and the vacant area information calculated in the materials location control device 1 from the location information storage device 104 are read (Step 2007), whether or not an available vacant area exists for each group is determined (Step 2008). If there is no vacant area available, the group is reorganized or divided again considering the area of the vacant area (Step 2009), and steps of Step 2004 onward are repeated. If there is a vacant area available to stock, the material names being stocked around the possible vacant area is read from the location information storage device 104 and also the process information of the materials control object is read from the process information storage device 902 are read (Step 2010), and whether there is a vacant area around which the materials control objects having the same or the nearest shipping date or the delivery request date at the site are stocked or not is determine (Step 2011), and if any, that area is determined to be the stock area. In this case, the allowable range of the same or near shipping date, delivery request date at the site and installation unit is registered in advance. As for the selection order of areas, although the area of the vacant area was prioritized in this example, the process information may be arranged to have priority. In addition, in a case where there is no materials control object having substantially same shipping date or the delivery request date around the area, the nearer or farther to/from the construction building depending on the shipping date or the delivery request date at the site is selected (Step 2012). Selection rules in that case may decide the priority of the vacant area according to size, shape, type, installation area and the like of the materials control objects.

The materials stockroom reserved for the materials control objects to be received afterwards is to correspond to each materials control object one to one basis, and no allocation to other materials control objects to be received. Owing to this, the receiving place and area information for the materials control objects to be received later is registered into the location information storage device 104 of the materials location control device 1, which is kept out when calculating the vacant area for other receiving materials control objects.

Coordinates of the receiving place and the optimal materials location method of the materials control objects when calculating the area is displayed or outputted as well as is transmitted to the materials shipping and receiving instruction device 3 which is in the hand of an operator (Step 2013).

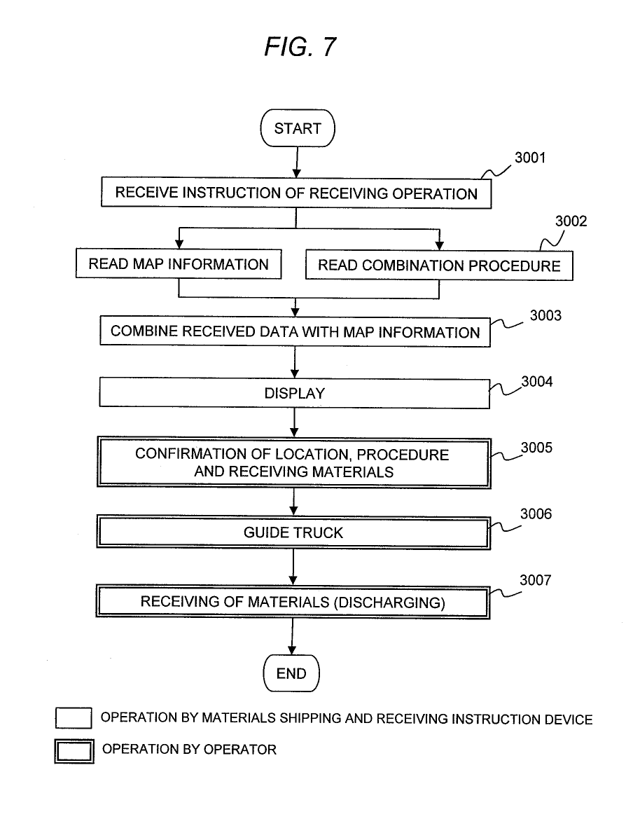

Next, operations of the materials shipping and receiving instruction device 3 and operator's work are described below taking an example of the materials receiving operation according to a work flow chart in FIG. 7. Operators involved in the receiving operation have the materials shipping and receiving instruction device 3 with themselves on receiving the materials control objects. Aforementioned coordinates of the receiving place transmitted from the materials control device 2 and the optimal materials location method of the materials control objects are received by the input device 302 (Step 3001) to store in the computing/memory device 301. Then, the materials stock area map and the coordinates information and also combination method of map information which has been registered in advance in the computing/memory device 301 are called from the materials storage location information storage device 303 to combine the coordinates of receiving place and the optimal materials location method of the materials control object with the map information (Step 3003), and the results of combination is displayed in the output device 304 (Step 3004). The material names and location method of the receiving objects may be combined in a map or shown in a chart or in a text format. The materials control object which is planned to be received later and only the place for which has been reserved is indicated to that effect. The operator confirms the indicated area, procedure and the material name to be received (Step 3005), guides the materials carrier loading the materials control objects to be received to the receiving area (Step 3006), discharges the materials control objects (Step 3007), and the receiving operation is completed.

Each work item of shipping operation of the materials control objects is described in detail.

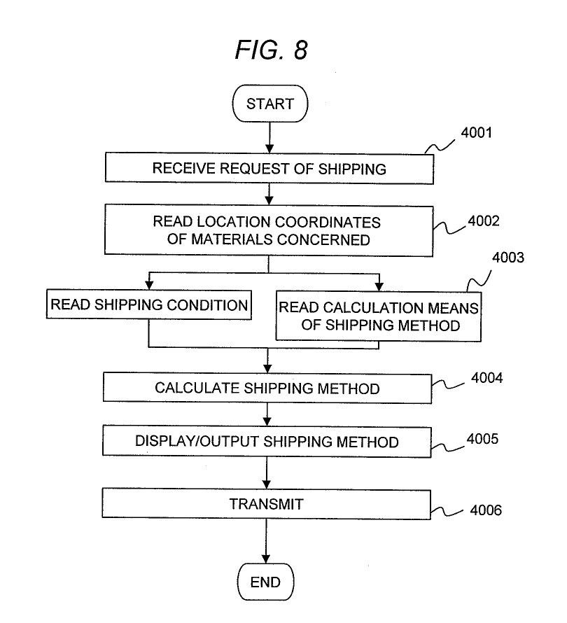

Operations of the materials control device 2 are described below taking an example of work according to a program flow chart in FIG. 8. Firstly, a shipping request including information of the name of the materials to be shipped, the specific ID of the transmitter, transportation destination, and the like is received (Step 4001). The shipping request may be plural. Location coordinates and location detection date of the materials control object to be shipped is read from the location information storage device 104 (Step 4002). Parameters to select shipping operations are read from the restriction condition storage device 202. Parameters read the materials carrier information such as utilization status of materials carrier for shipping, load capacity of the materials carrier which is available on the shipping date, driving qualification and the like, and traveling time information such as traveling time of each materials carrier at the materials stock area, traveling time of each materials carrier between the stockroom and the construction site, which is a transportation destination, number of times of loading operation, working time for loading operation, number of times of discharging for shipped materials, working time for materials grouping depending on the materials volume to be discharged, and the like, and then read from the computing/memory device 201 the calculation means of shipping method which was registered in advance (Step 4003). Discharging times of the shipped materials are required to be reduced. If materials are divided into the classes of shipping locations at materials loading operation, an operation for selecting the materials may be required at materials discharging operation when plural materials FOR plural shipping locations are transported at the same time in order to effectively use the loading capacity of the materials carrier. Therefore, considering the number of receivers of the shipped materials, transportation volume at each receiver of the shipped materials and the loading capacity of the materials carrier, it is necessary to judge if the loaded materials combination is easy to classify and to determine whether or not to use the same carrier to deliver the materials to a plurality of receivers. Materials sorting out time accompanied with the materials volume discharged implies an additional operation work time such as materials discrimination operation which occurs in a case where a plurality of shipping requests have an identical destination and the materials concerned are transported in one lot. The computing/memory device 201 calculates an optimal materials shipping method of the shortest work time conformed with the materials shipping request using parameters read out from the restriction condition storage device 202, considering the whole work time from shipping to discharging of the shipped materials control objects. When a plurality of materials carriers are required, calculation includes dividing of the materials control objects to be transported for each materials carrier based on the work time for shipping and the work time for discharging shipped materials control objects. Parameters used for calculation does not always include all of the parameters mentioned above, but the necessary parameters are to be determined in advance to set on a case-by-case basis. As an example of work time comparison, the following comparison study can be raised. That is, when the materials control objects are stocked at plural areas in scattered manner due to alteration of design or processes, which method is better, to use a big carrier moving in a materials storage location to collect and ship the materials in one time, or to use a small carrier to ship in plural times. The location information of the materials control object to be shipped and the working procedure as a result of calculation are displayed on the display device (Step 4005), and transmitted by the output device (Step 4006).

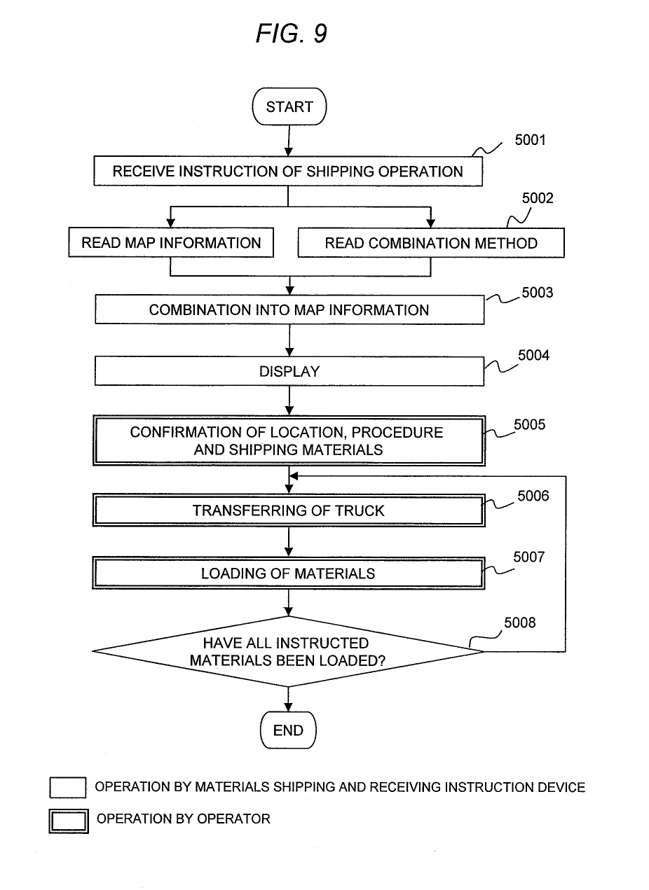

Operations of the materials shipping and receiving instruction device 3 and operator's work are described below taking an example of the materials shipping operation according to a work flow chart in FIG. 9. The location information of the materials control object to be shipped, which is transmitted from the materials control device 2 and the working procedure are received (Step 5001). The map information is read from the materials storage location information storage device 303 and the method to combine the received location information of the materials control object with the map information registered in advance into the computing/memory device 301 is called (Step 5002). The materials control object location information is combined with the map information at the computing/memory device 301 (Step 5003). The above mentioned combination result and the working procedure are displayed in the output device 304 (Step 5004). The working procedure is displayed in a text or chart format on a screen, which may be combined into the map information using marks such as arrows to display on the map. The operator confirms the location coordinates of the materials control object to be shipped displayed in the output device 304 and the working procedure (Step 5005), and moves the materials carrier for shipping to the location of the materials control object to be shipped (Step 5006). If the operator is not the driver of the carrier, the operator guides the carrier. The operator loads the materials control object to be shipped and confirms whether all the materials have been loaded at the materials shipping and receiving instruction device 3. If some of the materials control objects concerned remain, operations from the Step 5006 are repeated. If any of the materials control objects concerned are not remained, loading completion button is pressed to complete the loading operation and transport to a specified spot. The information that the loading completion button has been pressed and the names of the materials control objects are transmitted by the output device 304, which completes the shipping operation.

Consignee of the materials control objects receives the report of loading completion, name information of the shipped materials control objects and the carrier information, which have been transmitted on the completion of the shipping operations. Any means of receiving method will do as long as the information is transferred to a terminal possessed by the consignee by means of sound or letters.

### The Second Embodiment

An example is described below how to deal with the case where there is a shortage of materials in shipping after the works of the first embodiment. When the operator completes the work and transport the materials in a state that some of the materials control objects to be shipped are remained due to operator's error in sipping operation, the materials control device 2 receives the information of loading completion transmitted from the above-mentioned materials shipping and receiving instruction device 3 and names of the shipped materials control object. The materials control device 2 transmits the instruction to collect the location information of the shipped materials control object to the materials location control device 1. The computing/memory device 101 of the materials location control device 1 receives the location information obtain instruction. The location information obtain instruction of the materials control object is transmitted to the base station 11 attached in the materials storage location. The base station 11 tries to communicate with the transmitter 12 attached to the shipped materials control object in non-contact manner. If the materials control object has been shipped, the coordinates thereof are not detected since the materials concerned does no exist in the materials stock area. However in a case where the materials control object to be shipped is remained, the coordinates thereof are detected and loading shortage occurrence is ascertained. The materials location control device 1 transmits the position detection result to the materials control device 2. The materials control device 2, if there is a shortage of shipping, the names and the required delivery date of the materials control object concerned, and the receiver information are arranged to be memorized in the computing/memory device 201. Simultaneously, the names of the materials control object involved in a shortage of shipping is reported to a person in charge for materials control or shipping instructing source from the output device 204. If there is an alternative materials carrier availability on a same day, transportation by the carrier is investigated. In investigation, similar to the other materials control objects to be shipped, the most suitable materials carrier is selected using the parameters registered in the restriction condition storage device. The information of the materials carrier is reported to the person in charge for the materials control and the shipping instruction source. If there is not any convenient transportation method of the materials on the same day, such notice is given to the person in charge for materials control and the shipping instruction source. The person in charge for materials control and the shipping instruction source judges whether another materials carrier is arranged or the transportation is to be on the following day. In a case where the shipping is by a materials carrier on the following day onwards, such plan is registered in the input device 203 of the materials control device 2. This registered information is treated same as a parameter registered in the restriction condition storage device to select the most suitable materials carrier. Once the materials carrier for shipping the materials control object involved in a shipping shortage, whenever the transportation date would be, the information of the materials control object and the carrier thereof is transmitted to the terminal possessed by the consignee.

### The Third Embodiment

Examples are described bellow concerning with shipping of wrong materials control objects, the case where shipping is carried out without a shipping notice in advance, and how to deal with the case of false taking-out of the materials control object.

According to the present system, since the materials to be shipped are located in a lump, mis-picking of materials is expected to be reduced significantly. In shipping operation, however, an operator judges exactness of the materials to be shipped, therefore mis-picking of the materials may happen due to similarity of the name or the shape, which possibly causes wrong materials shipping. In addition, under such a system that constructors come to the materials storage location to pick up the necessary materials without intervention of transporter, it is conceivable that the materials for future requirement may be picked up together without shipping request to save the bother of coming to the stockroom. In some cases, differing from the former cases, returning of the materials may not be necessary. Therefore appropriateness of the person in charge for shipping operation and the materials to be shipped must be evaluated.

Similar with the Second embodiment, the materials control device 2 receives the information of loading completion transmitted from the aforementioned materials shipping and receiving instruction device 3 and the names of the shipped materials control object after processes of Second embodiment. The materials control device 2 transmits an instruction to collect the location information of the materials control object including the materials shipped to the materials location control device 1. The computing/memory device 101 of the materials location control device 1 receives the location information obtaining instruction. The location information obtaining instruction of the materials control object is transmitted to the base station 11 installed in the materials storage location. The base station 11 tries to communicate with the transmitter 12 which is attached to all of the materials control objects. The materials location control device 1 replies to the materials control device 2 the names of the materials control objects attached with the transmitter 12 to which the base station 11 could communicate with.

The materials control device 2 compares the name of the materials control object stocked in the materials storage location before receiving the loading completion information from the materials shipping and receiving instruction device 3 with the name of the materials control object which can communicate after receiving. Based on comparison, the name of the materials control object which was taken out can be extracted. The extracted materials control object which is not the materials control object to be shipped can be the object taken out by mistake or taken out materials without shipping request. The former materials are required to be returned, but the latter materials may not be required to be returned if the materials are necessary for the operator in future, therefore evaluation of appropriateness of taking out materials is required.

Construction management covers information control of operators. A trader to which an operator belongs defines the operation in charge. In addition, applying work progress control in daily basis, subsequent working area is decided by the instruction or declaration of working plan. The operator issues a shipping request based on this working plan. Consequently, specifying the trader makes it possible to evaluate appropriateness of the materials taking out.

The trader of the materials shipping is specified, thus carriers used by the trader are attached with the transmitters as same as the transmitters attached to the materials control objects and specific numbers are registered to the transmitters in advance to control by the materials location control device. Alternatively, if there is a person in charge on worksite of shipping, the shipping trader may be registered when the loading completion information is transmitted from the materials shipping and receiving instruction device 3.

The obtained information of the trader is checked up with the materials control object which has been taken out although not to be shipped. If the trader in concern is not a trader which requires the materials control object, a warning is given and a person in charge of the materials control requests the trader to return the materials control object which has been taken out erroneously. If the trader is the one which requires the materials, an adjustment is carried out between the person in charge of materials control and the trader to decide whether the materials is to be shipped as they are or to request to return based on expected timing to use the materials control object or necessity thereof. Automatic judgement may be applied whether the materials is deemed to be shipped or to be returned through determining a threshold of future timing to use.

Owing to this, appropriate materials control can be performed by tracking the materials taken out erroneously and intentional shipping without request.

Furthermore, attaching transmitter to the all carriers which enter into the premise of worksite to check locations of all materials control objects periodically so that false taking out can be detected.

### The Fourth Embodiment

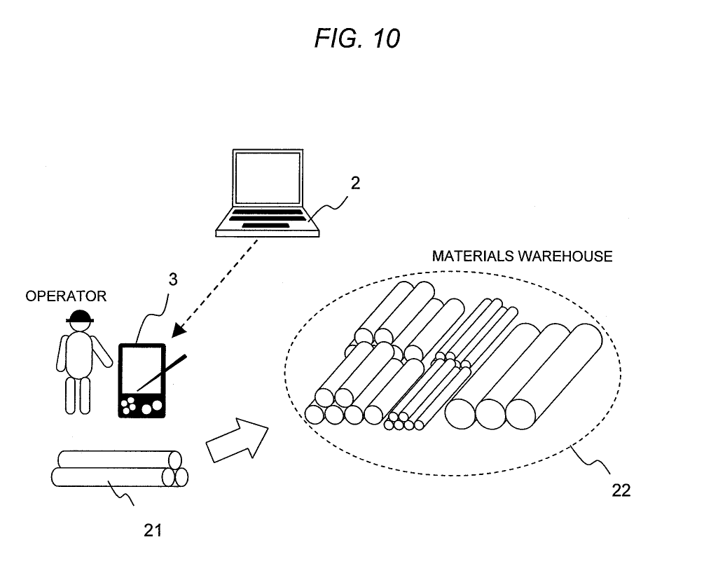

As an example of utilization of the materials control device 2, an example of raw materials receiving in a raw materials stock warehouse shown in FIG. 10 is described. In this Example, taking raw materials control in a piping process factory as an example, the materials control object is supposed to be a raw materials and the materials storage location is supposed to be a raw materials stock warehouse. The receiving report of the raw materials 21 from the input device 203 is received, dimensions and size information of the raw materials is read from the design information storage device 901, location information of the stock raw materials 22 in the raw materials stock warehouse is read from the location information storage device 104, further process information of the receiving raw materials 21 and the stock raw materials 22 are read from the process information storage device 902. Next, raw materials stock restriction condition is read from the restriction condition storage device 202. The restriction condition includes conditions to stack the raw materials safely and stock conditions of each type of the raw materials. The computing/memory device 201 calculates a stock-in place conforming with the restriction condition so that the first-out raw materials is stocked upper side and the shorter shipping route for the earlier shipping materials, which is displayed or outputted in the output device 204. If the operator is carrying the materials shipping and receiving instruction device 3, the stock-in area instruction information is transmitted from the output device 204. Thus the operator can take the efficiency of raw materials shipping operation into consideration and achieve a safe stock-in operation.

1. A materials location system having an information storage device storing materials storage location information, location coordinates of stocked materials control object, and design information of materials control object and a materials location control device having a computing device, said materials location system comprising:
a materials location control device having means for calculating locations of the materials control objects stocked at the materials storage location and area and coordinates of areas where the materials control objects are not placed, from the storage location information, the location coordinates of stocked materials control object, and the design information from which dimensions and shapes of the materials control objects can be recognized.

2. The materials location system according to claim 1, wherein, said materials location control device includes means to automatically obtain the location coordinates of the materials control objects attached with a transmitter, by utilizing a base station which detects positions by transmitting and receiving radio wave in non-contact manner and the transmitter which transmits information stored in advance, as means to detect the location coordinates of the stocked materials control objects, and to automatically calculate the locations of the stocked materials control objects and area and coordinates of places where the materials control objects are not placed.

3. The materials location system according to claim 1, further comprising:
a first storage device for storing information on location of the stocked materials control object and on the place where no materials control objects are placed, the information being calculated by the materials location control device;
a second storage device which stores design information from which dimensions and shapes of the materials control objects are recognized when receiving the materials control objects at the materials storage location and process information; and
a computing device.
wherein said materials control device includes means for selecting a storage location so as to minimize work volume for shipping when shipping the materials control objects.

4. The materials location system according to claim 3, further comprising:
means for selecting a storage location so as to minimize work volume for shipping when receiving the materials control objects, considering sizes of the materials control objects which arrive afterwards in the case where the materials control objects arriving afterwards have to be placed in the same area,
wherein said materials control device includes means for reserving a materials storage location so that a materials stockroom kept vacant for the materials control objects arriving afterwards is not allocated to other materials.

5. The materials location system according to claim 3, wherein said materials control device includes means for selecting a storage location in view of safety restriction condition and process information when the materials control objects are stocked in stacked manner.

6. The materials location system according to claim 3, wherein said materials control device includes means for grouping process information, areas required to stock, and materials control objects so as to minimize work volume for shipping in the case where no materials control objects placed areas are smaller than areas required to stock materials control objects to be newly received and in the case where the materials control objects to be newly received are plural.

7. The materials location system according to claim 3, wherein said materials control device includes means for indicating location coordinates of the materials control objects to be shipped at shipping operation of the materials control objects, means for calculating shipping means and a shipping sequence to minimize work volume for shipping, and means for instructing said location coordinates, calculated shipping means and shipping sequence to operators.

8. The materials location system according to claim 3, further comprising means for detecting shipping missing of the materials control objects from location coordinates of the materials control objects, information of the materials control objects to be shipped, and shipping completion information to automatically report to persons concerned, and to review transportation plan automatically.

9. The materials location system according to claim 3, further comprising means for verifying appropriateness of materials carrier, transporter, or combination of the shipped materials control objects, to automatically detect wrong shipped materials control objects different from shipping plan or arbitrary shipping of the materials control objects out of shipping schedule, and to perform automatic report to persons concerned, making use of location coordinates of the materials control objects, information of the materials control objects to be shipped, location of materials carrier and names of control trader, and shipping completion information.

10. A materials receiving location selecting method for controlling materials control objects controlled in a materials storage location, comprising:
a location detecting step for automatically obtaining location coordinates of the materials control objects attached with a transmitter by means of communication between a base station detecting location through transmitting and receiving radio wave in non-contact manner and the transmitter transmitting information stored in advance;
a location calculating step for calculating location of the materials control objects stocked in a materials storage location and area and coordinates of vacant places where no materials control objects are placed by use of storage location information, location coordinates of the stocked materials control objects and design information from which dimensions and shapes of the materials control objects can be recognized; and
an information collecting step for extracting design information of the materials control objects stocked around places where said materials control objects are not placed,
wherein receiving operation is assisted through selection of vacant place for receiving objects so as to minimize work volume for shipping operation based on volume of the materials control objects to be received hereafter and design information.
